(19) United States
(12) Patent Application Publication
(10) Pub. No.: US 2016/0134143 A1
(43) Pub. Date: May 12, 2016

(54) ELECTRONIC CIGARETTE CASE

(71) Applicant: KIMREE HI-TECH INC., Tortola (VG)

(72) Inventor: QIUMING LIU, Huizhou City, Guangdong Province (CN)

(21) Appl. No.: 14/414,892

(22) PCT Filed: May 28, 2013
(86) PCT No.: PCT/CN2013/076309

§ 371 Date: Jan. 24, 2016

(51) Int. Cl. H02J 7/00; B65D 85/00; A24F 47/00

(52) U.S. Cl. CPC H02J 7/0045; A24F 47/008; B65D 85/70

(57) ABSTRACT

An electronic cigarette case, comprising a case body. The case body is provided on a surface thereof with an accommodation groove. The accommodation groove has movably accommodated therein a charging connector. The charging connector has arranged thereon a first magnetic piece. The accommodation groove has arranged at one side thereof a second magnetic piece that is matched with and magnetically attracted to the first magnetic piece. By employing the technical means of having arranged on the charging connector the first magnetic piece and of having arranged at one side of the accommodation groove the second magnetic piece that is matched with and magnetically attracted to the first magnetic piece, the electronic cigarette case achieves reliable quality and the technical effect that the charging connector does not come loose and allows the charging connector to be fixed without requiring an interference fit.

### FIELD OF THE INVENTION

The present invention relates to an electronic cigarette case.

### BACKGROUND OF THE INVENTION

A bottom end of a case body of a conventional electronic cigarette case disposes an accommodation groove which is used to accommodate USB plug. The case body disposes a charging module therein used for charging the electronic cigarette. The USB plug is electrically connected with the charging module, and is accommodated in the accommodation groove by interferingly fitting to make the USB plug being fixed.

However, when using the USB plug to charge the electronic cigarette, it is needed to pull out the USB plug from the accommodation groove by finger. With increase of use frequency, the USB plug wears more and more serious, and effect of interferingly fitting becomes worse, which causes the USB plug easy to fall out.

### SUMMARY OF THE INVENTION

Therefore, the present invention provides an electronic cigarette case with reliable quality and a charging connector thereof is not loose.

To achieve the above-mentioned objective, an embodiment of the present invention provides an electronic cigarette case, including a case body. A surface of the case body disposes an accommodation groove therein. The accommodation groove movably accommodates a charging connector. The charging connector disposes a first magnetic piece. One side of the accommodation groove disposes a second magnetic piece matched with and magnetically attracted to the first magnetic piece. Therefore, by the first magnetic piece and the second magnetic piece which are mutually matched and magnetically attracted, on the one hand, the charging connector will be firmly hold, and will not loose and fall from the accommodation groove. On the other hand, no interference fit is required when designing and manufacturing, effect of fixing the charging connector can also be achieved, and clamping strength is proper for taking out.

Furthermore, the accommodation groove is disposed at a bottom end of the case body.

Furthermore, the second magnetic piece is disposed at a bottom of the accommodation groove.

Furthermore, the first magnetic piece is a shielding shell which is made of magnetic material and is disposed on the charging connector. The second magnetic piece is a magnet and is securely disposed at a position at the bottom of the accommodation groove corresponding to the first magnetic piece. Preferably, the charging connector is a USB plug connector. Then effect of an existing metal at a bottom portion of the USB plug connector to be attracted by the second magnetic piece is achieved, so it is not required to add other component or to improve process, which saves cost and product manufacturing is simple and fast.

Furthermore, the first magnetic piece is a magnet, and the second magnetic piece is a plate made of magnetic material and is securely disposed at a position at the bottom of the accommodation groove corresponding to the first magnetic piece.

Furthermore, both the first magnetic piece and the second magnetic piece are magnets, and the positions of the first magnetic piece and the second magnetic piece are corresponding, and polarity of the corresponding surfaces is opposite. Therefore, by the corresponding positions and magnets with polarity of the corresponding surfaces being opposite, when the charging connector needs to be loaded into the accommodation groove by a special way, such as one side being placed outside and the other side being inside, achieves effect of fool-proof.

Furthermore, the charging connector is a USB plug connector or a USB socket connector.

Furthermore, the case body disposes a charging module therein which is used to charge the electronic cigarette. The charging module is connected with the charging connector by a conducting wire.

Furthermore, one end of the accommodation groove disposes a pulling space which is used to facilitate finger to pull out the charging connector. Preferably, the pulling space is disposed at the end of the accommodation groove corresponding to an interface of the charging connector. Therefore, by the pulling space, it is facilitated that users pull out of the charging connector.

Furthermore, a bottom of the case body further disposes a cover plate which is used to cover an opening of the accommodation groove. Therefore, by the cover plate, on the one hand, appearance of the case body is beautiful after the cover plate covering; on the other hand, dust is prevented from entering and misused is prevented by child.

Furthermore, the magnetic material is one or more of iron, cobalt, nickel and neodymium and alloy materials.

The beneficial effects of the electronic cigarette case of the embodiment of the present invention are: by employing the technical means of disposing the first magnetic piece on the charging connector, and at the bottom of the accommodation groove disposes the second magnetic piece which is matched with and magnetically attracting to the first magnetic piece, therefore achieves the technical effects of reliable quality and the charging connector will not loose from; in addition, interference fit is not required when designing and manufacturing, and the charging connector can be fixed.

### BRIEF DESCRIPTION OF THE DRAWINGS

FIG. 1 is a perspective view of an electronic cigarette case according to an embodiment of the present invention.

FIG. 2 is a sectional view of the electronic cigarette case according to the embodiment of the present invention.

FIG. 3 is an enlarged schematic view of M position in the FIG. 2.

FIG. 4 is an exploded view of the electronic cigarette case according to the embodiment of the present invention.

### DETAILED DESCRIPTION OF THE INVENTION

It is needed to state that embodiments and all element limitations in all embodiments may be combined in the case of no conflicts. The present invention will be described in detail in the following combining figures and embodiments.

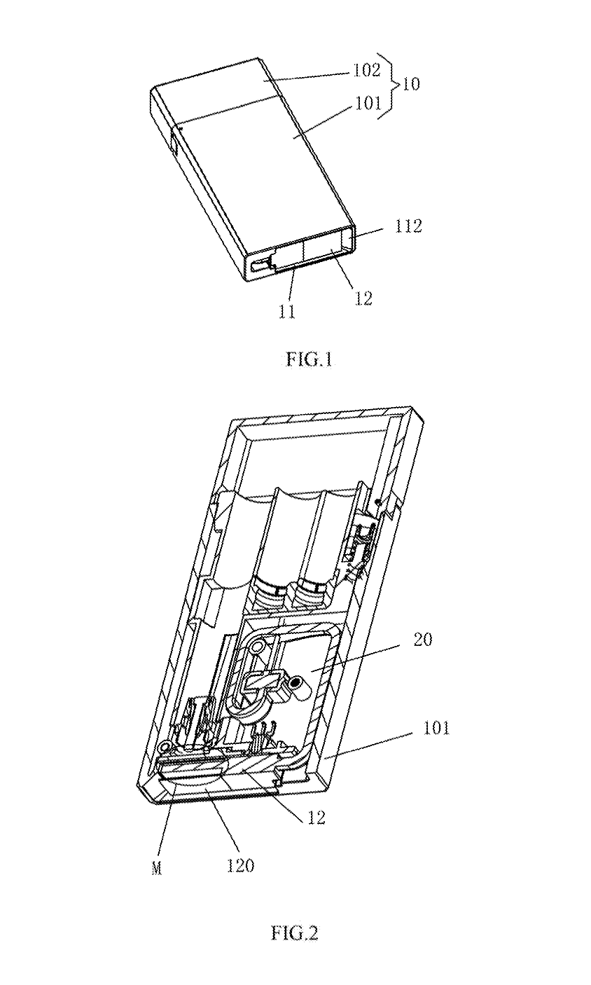

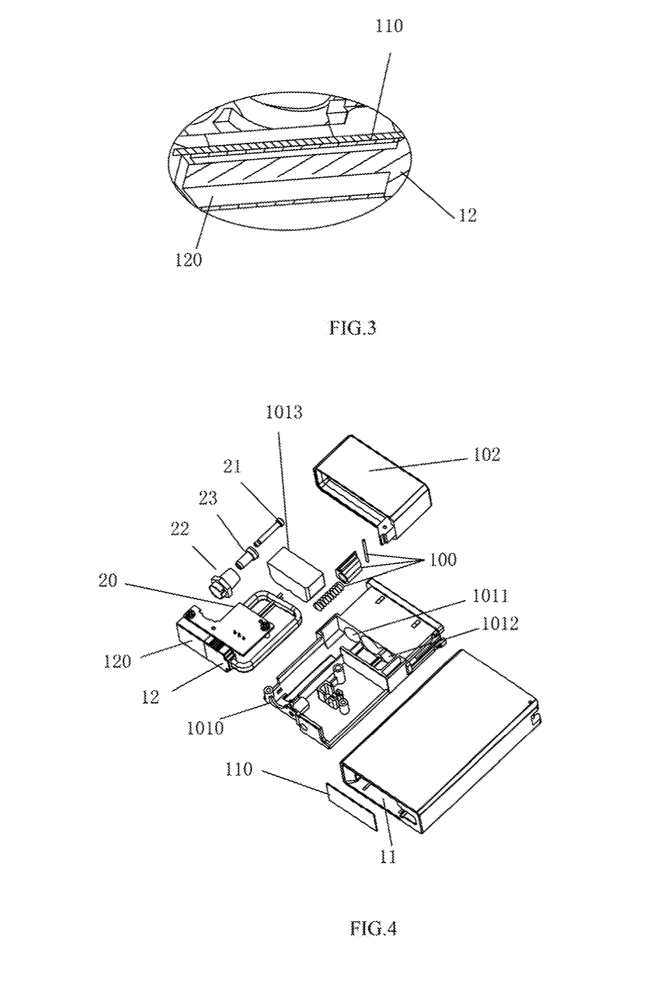

Referring to FIG. 1 to FIG. 3, the present invention provides an electronic cigarette case, a main body of the electronic case is a case body 10, and on a surface of the case body 10 disposes an accommodation groove 11. Preferably, the accommodation groove 11 is disposed at a bottom end of the case body 10. The accommodation groove 11 movably accommodates a charging connector 12 therein. On the charging connector 12 disposes a first magnetic piece 120. One side of the accommodation groove 11 disposes a second magnetic piece 110 which matches with and magnetically attracts with the first magnetic piece 120. Preferably, the second magnetic piece 110 is disposed at a bottom of the accommodation groove 11. Therefore, by the first magnetic piece 120 and the second magnetic piece 110 which are mutually matched and magnetically attracted, on the one hand, the charging connector 12 will be firmly hold, and will not loose and fall from the accommodation groove 11. On the other hand, no interference fit is required when designing and manufacturing, effect of fixing the charging connector 12 can also be achieved, and clamping strength is proper for taking out.

As an embodiment, the first magnetic piece 120 is a shielding shell which is made of magnetic material and is disposed on the charging connector 12. The second magnetic piece 110 is a magnet and is securely disposed at a position at the bottom of the accommodation groove 11 corresponding to the first magnetic piece 120. Preferably, the charging connector 12 is a USB plug connector. Then effect of an existing metal at a bottom portion of the USB plug connector to be attracted by the second magnetic piece 110 is achieved, so it is not required to add other component or to improve process, which saves cost and product manufacturing is simple and fast.

As another embodiment, the first magnetic piece 120 is a magnet, and the second magnetic piece 110 is a plate made of magnetic material and is securely disposed at a position at the bottom of the accommodation groove 11 corresponding to the first magnetic piece 120. Specifically, in the above-mentioned two embodiments, the magnetic material is one or more of iron, cobalt, nickel and neodymium and alloy materials.

As a further embodiment, both the first magnetic piece 120 and the second magnetic piece 110 are all magnets, and positions thereof are corresponding, and polarity of the corresponding surfaces is opposite. Therefore, by the corresponding positions and magnets with polarity of the corresponding surfaces being opposite, when the charging connector 12 needs to be loaded into the accommodation groove 11 by a special way, such as one side being placed outside and the other side being inside, achieves effect of fool-proof.

Preferably, the charging connector 12 is a USB plug connector or a USB socket connector.

The case body 10 disposes a charging module 20 therein which is used to charge the electronic cigarette. The charging module 20 is connected with the charging connector 12 by a conducting wire.

One end of the accommodation groove 11 disposes a pulling space 12 for facilitating finger to pull out the charging connector 12. Preferably, the pulling space 12 is disposed at one end of the accommodation groove 11 corresponding to an interface of the charging connector 12. Therefore, by the pulling space 12, it is facilitated that users pull out of the charging connector 12.

At the bottom of the case body 10 further disposes a cover plate (not shown in figures) which is used to cover an opening of the accommodation groove 11. Therefore, by the cover plate, on the one hand, appearance of the case body 10 is beautiful after the cover plate covering; on the other hand, dust is prevented from entering and misused is prevented by child.

Also referring to FIG. 4, the case body 10 of the embodiment of the present invention includes a bottom case 101 and a case cover 102 which is pivoted with the bottom case 101.

The bottom case 101 is a square shell, and certainly a shape of the bottom case 101 is not limited to square, for example, and also may be round, oval, polygonal. The case cover 102 may fit with the bottom case 101. The case cover 102 is movably connected with the bottom case 101 by a pivot assembly 100. The bottom case 101 disposes a first support 1010 therein which is used to clamp and support the electronic cigarette. On the first support 1010 further disposes a cigarette rod accommodation chamber 1011 for accommodating a cigarette rod, and a cartridge accommodation chamber 1012 for accommodating a cartridge, and disposes a fixing seat 1013 which is used to fix the cartridge. The fixing seat 1013 is made of elastic silica gel.

The charging module 20 is also fixed on the first support 1010. The charging module 20 further disposes a first electrode piece 21 which is electronically connected with a first electrode in an inserting end of the electronic cigarette to be charged, and a second electrode piece 22 which is electronically connected with a corresponding second electrode. Between the first electrode piece 21 and the second electrode piece 22 disposes a fixing sleeve 23 used for insulation.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette case, comprising:
a case body, a surface of the case body disposing an accommodation groove, the accommodation groove movably accommodating a charging connector;
wherein the charging connector disposes a first magnetic piece, one side of the accommodation groove disposes a second magnetic piece matched with and magnetically attracted to the first magnetic piece.

2. According to the electronic cigarette case in claim 1, wherein the accommodation groove is defined at a bottom end of the case body.

3. According to the electronic cigarette case in claim 2, wherein the second magnetic piece is disposed at a bottom of the accommodation groove.

4. According to the electronic cigarette case in claim 3, wherein the first magnetic piece is a shielding shell which is made of magnetic material and is disposed on the charging connector, the second magnetic piece is a magnet and is securely disposed at a position at the bottom of the accommodation groove corresponding to the first magnetic piece.

5. According to the electronic cigarette case in claim 3, wherein the first magnetic piece is a magnet, and the second magnetic piece is a plate made of magnetic material and is securely disposed at a position at the bottom of the accommodation groove corresponding to the first magnetic piece.

6. According to the electronic cigarette case in claim 1, wherein the first magnetic piece and the second magnetic piece are magnets, and positions of the first magnetic piece and the second magnetic piece are corresponding, and polarity of the corresponding surfaces of the first magnetic piece and the second magnetic piece is opposite.

7. According to the electronic cigarette case in claim 1, wherein the charging connector is a universal serial bus (USB) plug connector or a USB socket connector.

8. According to the electronic cigarette case in claim 1, wherein the case body disposes a charging module therein which is used to charge the electronic cigarette.

9. According to the electronic cigarette case in claim 1, wherein one end of the accommodation groove disposes a pulling space which is used to facilitate finger to pull out the charging connector.

10. According to the electronic cigarette case in claim 1, wherein at a bottom of the case body further disposes a cover plate which is used to cover an opening of the accommodation groove.

11. According to the electronic cigarette case in claim 4, wherein the magnetic material is one or more of iron, cobalt, nickel and neodymium and alloy materials.

12. According to the electronic cigarette case in claim 2, wherein the charging connector is a universal serial bus (USB) plug connector or a USB socket connector.

13. According to the electronic cigarette case in claim 2, wherein the case body disposes a charging module therein which is used to charge the electronic cigarette.

14. According to the electronic cigarette case in claim 2, wherein one end of the accommodation groove disposes a pulling space which is used to facilitate finger to pull out the charging connector.

15. According to the electronic cigarette case in claim 3, wherein the charging connector is a universal serial bus (USB) plug connector or a USB socket Connector.

16. According to the electronic cigarette case in claim 3, wherein the case body disposes a charging module therein which is used to charge the electronic cigarette.

17. According to the electronic cigarette case in claim 3, wherein one end of the accommodation groove disposes a pulling space which is used to facilitate finger to pull out the charging connector.

18. According to the electronic cigarette case in claim 4, wherein one end of the accommodation groove disposes a pulling space which is used to facilitate finger to pull out the charging connector.

19. According to the electronic cigarette case in claim 4, wherein the case body disposes a charging module therein which is used to charge the electronic cigarette.

20. According to the electronic cigarette case in claim 4, wherein the charging connector is a universal serial bus (USB) plug connector or a USB socket connector.
